(19) United States
(12) Patent Application Publication
(10) Pub. No.: US 2007/0160236 A1
(43) Pub. Date: Jul. 12, 2007

(54) Audio signal encoding device, audio signal decoding device, and method and program thereof

(76) Inventors: Kazuhiro Iida, Yokohama-shi (JP); Mineo Tsushima, Nara-shi (JP); Yoshiaki Takagi, Yokohama-shi (JP); Naoya Tanaka, Neyagawa-shi (JP)

Correspondence Address: WENDEROTH, LIND & PONACK L.L.P., 2033 K. STREET, NW, SUITE 800, WASHINGTON, DC, 20006, US

(21) Appl. No.: 10/589,818

(22) PCT Filed: Jul. 1, 2005
(86) PCT No.: PCT/JP05/12221

§ 371 Date: Aug. 17, 2006

(30) Foreign Application Priority Data
Jul. 6, 2004 (JP) 2004-199819

(51) Int. Cl. H04B 1/00; H04B 1/20

(52) U.S. Cl. 381/119; 369/4

(57) ABSTRACT

An audio signal encoding device includes a downmix signal encoding unit 203 and an auxiliary information generation unit 204. The downmix signal encoding unit 203 generates a downmix signal acquired by adding input signals each other using a predetermined method, encodes the downmix signal, and outputs downmix signal information 206. The auxiliary information generation unit 204 generates auxiliary information 205 using the downmix signal and the downmix signal information 206 generated by the downmix signal encoding unit 203. The auxiliary information generation unit 204 efficiently quantizes the auxiliary information 205 using human's characteristics of a perceptual direction of a sound source, a perceptual broadening, and a perceptual distance.

### TECHNICAL FIELD

The present invention relates to an audio signal encoding device, an audio signal decoding device, and a method and program thereof.

### BACKGROUND ART

As a conventional audio signal encoding method and decoding method, an international standard method by the ISO/IEC commonly termed as the Motion Picture Experts Group (MPEG) method and the like have been known. Currently, the ISO/IEC 13818-7 commonly termed as the MPEG 2 Advanced Audio Coding (AAC), and the like has been employed for its wide range of applications as a coding method which provides high sound quality while keeping the bit rate low. Some standards extended from the present method are under formulation.

One of the extended standards is a technique of using information called Spatial Cue Information or Binaural Cue information. As an example of such a technique, there is provided a Parametric Stereo method defined by the MPEG-4 Audio (ISO/IEC 14496-3) that is an ISO international standard. Further, the United States Patent US2003/0035553 titled “Backwards-compatible Perceptual Coding of Spatial Cues” discloses a method as another example of the above (see non-patent reference 1). Additionally, other examples are suggested (e.g. see patent reference 1 and patent reference 2).
Non-Patent Reference 1: ISO/IEC 14496-3:2001 AMD2 “Parametric Coding for High Quality Audio”
Patent Reference 1: United States Patent No US2003/0035553 “Backwards-compatible Perceptual Coding of Spatial Cues”
Patent Reference 2: United States Patent US2003/0219130 “Coherence-based Audio Coding and Synthesis”

### DISCLOSURE OF INVENTION

### Problems that Invention is to Solve

However, it is difficult to realize a low bit rate by the conventional audio signal encoding method and decoding method because the AAC described in the background art, for example, does not make the most use of a correlation between channels when multi-channel signals are coded. Even in the case where encoding is performed using the correlation between channels, there is a problem that an effect of increasing encoding efficiency, which could be obtained using human's characteristics of a perceptual direction of a sound source and a perceptual broadening, is not efficiently employed for processing of quantization and encoding.

Also, in the conventional method, in the case where the encoded multi-channel signals are decoded and reproduced through two speakers and headphones, all channels have to be decoded once, and an audio signal to be reproduced through the two speakers and the headphones then has to be generated by adding the decoded signals each other using a method such as down-mixing. This requires large amount of calculations and a buffer for the calculations when the audio signal is reproduced through two speakers and headphones, causing increases of power consumption and cost of a calculation unit such as a DSP which implements the calculation.

In order to solve the aforementioned problems, an object of the present invention is to provide an audio signal encoding device which increases encoding efficiency when encoding multi-channel signals, and an audio signal decoding device which decodes the codes obtained from said encoding device.

### Means to Solve the Problems

An audio signal encoding device of the present invention is an audio signal encoding device which encodes original sound signals of respective channels into downmix signal information and auxiliary information, the downmix signal information indicating an overall characteristic of the original sound signals, and the auxiliary information indicating an amount of characteristic based on a relation between the original sound signals, the device including: a downmix signal encoding unit which encodes a downmix signal acquired by downmixing the original sound signals so as to generate the downmix signal information; and an auxiliary information generation unit which: calculates the amount of characteristic based on the original sound signals; when channel information indicating reproduction locations, as seen by a listener, of sounds of respective channels is given, determines an encoding method that differs depending on a location relation of the reproduction locations indicated in the given channel information; and generates the auxiliary information by encoding the calculated amount of characteristic using the determined encoding method.

Also, the auxiliary information generation unit which retains tables in advance, each table defining quantization points at which different quantization precisions are achieved, and the auxiliary information generation unit may encode the amount of characteristic by quantizing the amount of characteristic at the quantization points defined by one of the tables which corresponds to the location relation of the reproduction locations indicated in the channel information.

In addition, the auxiliary information generation unit may calculate, as the amount of characteristic, at least one of a level difference and a phase difference between the original sound signals. Further, it may calculate, as the amount of characteristic, a direction of an acoustic image presumed to be perceived by the listener, based on the calculated level difference and phase difference.

Also, the auxiliary information generation unit retains a first table and a second table in advance, the first table defining quantization points provided laterally symmetrical seen from a front face direction of the listener, and the second table defining quantization points provided longitudinally asymmetrical seen from a left direction of the listener, and the auxiliary information generation unit may encode the amount of characteristic (a) by quantizing the amount of characteristic at the quantization points defined by the first table, in the case where the channel information indicates front left and front right of the listener, and (b) by quantizing the amount of characteristic at the quantization points defined by the second table, in the case where the channel information indicates front left and rear left of the listener.

In addition, the auxiliary information generation unit may calculate, as the amount of characteristic, a degree of similarity between the original sound signals. Further, it may calculate, as the degree of similarity, one of a cross-correlation value between the original sound signals and an absolute value of the cross-correlation value. Furthermore, it may calculate, as the amount of characteristic, at least one of a perceptual broadening and a perceptual distance of an acoustic image presumed to be perceived by the listener, based on the calculated degree of similarity.

In order to solve the aforementioned problem, an audio signal decoding device of the present invention is an audio signal decoding device which decodes downmix signal information and auxiliary information into reproduction signals of respective channels, the downmix signal information indicating an overall characteristic of original sound signals of the respective channels, and the auxiliary information indicating an amount of characteristic based on a relation between the original sound signals, the device including: a decoding method switching unit which determines, when channel information indicating reproduction locations, as seen by a listener, of sounds from the respective channels is given, a decoding method that differs depending on a location relation of the reproduction locations indicated in the given channel information; an inter-signal information decoding unit which decodes the auxiliary information into the amount of characteristic using the determined decoding method; and a signal synthesizing unit which generates the reproduction signals of the respective channels, using the downmix signal information and the decoded amount of characteristic.

Also, the auxiliary information is encoded by quantizing the amount of characteristic at quantization points defined by a table corresponding to the location relation of the reproduction locations indicated in the channel information, the table being one of tables, each defining quantization points at which different quantization precisions are achieved, the inter-signal information decoding unit retains the tables in advance, and the inter-signal information decoding unit may decode the auxiliary information into the amount of characteristic using one of the tables which corresponds to the location relation of the reproduction locations indicated in the channel information.

In addition, the amount of characteristic indicates at least one of a level difference, phase difference between the original sound signals, and a direction of an acoustic image presumed to be perceived by the listener, the inter-signal information decoding unit retains a first table and a second table in advance, the first table defining quantization points provided laterally symmetrical seen from a front face direction of the listener, and the second table defining quantization points provided longitudinally asymmetrical seen from a left direction of the listener, and the inter-signal information decoding unit may decode the auxiliary information (a) into the amount of characteristic using the first table, in the case where the channel information indicates front left and front right of the listener, and (b) into the amount of characteristic using the second table, in the case where the channel information indicates front left and rear left of the listener.

Also, the amount of characteristic may indicate at least one of a level difference, a phase difference and a similarity between the original sound signals, and a direction of an acoustic image, a perceptual broadening and a perceptual distance which are presumed to be perceived by the listener.

Also, the signal synthesizing unit may generate the reproduction signal, in the case where the amount of characteristic indicates at least one of the level difference, phase difference and similarity between the original sound signals, by applying a level difference, a phase difference and a similarity which correspond to the amount of characteristic, to a sound signal indicated by the downmix signal information.

In addition, the present invention can be realized not only as such audio signal encoding device and the audio signal decoding device, but also as a method including, as steps, processing executed by characteristic units of such devices, and as a program for causing a computer to execute those steps. Also, it is obvious that such program can be distributed through a recording medium such as a CD-ROM and a transmission medium such as the Internet.

### Effects of the Invention

According to the audio signal encoding device and decoding device of the present invention, in the case of generating auxiliary information for separating, from a downmix signal obtained by downmixing original sound signals, a reproduction signal approximated to the original sound signals, the signals can be separated so as to be auditory reasonable and very small amount of auxiliary information can be generated.

Further, by configuring to obtain, as the downmix signal, two downmix signals of left and right channels, each as the aforementioned downmix signal, from the multi-channel original sound signals, a stereo reproduction with high sound quality and low calculation amount can be realized only by decoding the downmix signals without processing the auxiliary information when the audio signal is reproduced through the speakers and headphones having a reproduction system for two channel signals.

### BRIEF DESCRIPTION OF DRAWINGS

FIG. 1 is a block diagram showing an example of a functional structure of an audio signal encoding device according to embodiments of the present invention.

FIG. 2 is a diagram showing an example of a location relation between a listener and a sound source indicated in channel information.

FIG. 3 is a functional block diagram showing an example of a structure of an auxiliary information generation unit.

FIG. 4A and FIG. 4B are diagrams, each of which shows a typical example of a table used for a quantization of a perceptual direction predicted value.

FIG. 5A and FIG. 5B are diagrams, each of which shows a typical example of a table used for a quantization of an inter-signal level difference and an inter-signal phase difference.

FIG. 6 is a functional block diagram showing another example of a structure of the auxiliary information generation unit.

FIGS. 7 are diagrams, each of which shows a typical example of a table used for a quantization of a degree of an inter-signal correlation, a degree of an inter-signal similarity and a predicted value of a perceptual broadening.

FIG. 8 is a functional block diagram further showing another example of a structure of the auxiliary information generation unit.

FIG. 9 is a block diagram showing an example of a functional structure of an overall audio signal decoding device according to the embodiments of the present invention.

FIG. 10 is a functional block diagram showing an example of a structure of a signal separation processing unit.

### NUMERICAL REFERENCES

102 Downmix signal decoding unit

103 Signal separation processing unit

105 First output signal

106 Second output signal

201 First input signal

202 Second input signal

203 Downmix signal encoding unit

204 Auxiliary information generation unit

205 Auxiliary information

206 Downmix signal information

207 Channel information

303 Inter-signal level difference calculation unit

304 Inter-signal phase difference calculation unit

305 Perceptual direction prediction unit

306 Encoding unit

401 Inter-signal correlation degree calculation unit

402 Perceptual broadening prediction unit

403 Encoding unit

502 Perceptual distance prediction unit

503 Encoding unit

702 Auxiliary information

704 Downmix signal decoding unit

705 Decoding method switching unit

706 Inter-signal information decoding unit

707 Signal synthesizing unit

### BEST MODE FOR CARRYING OUT THE INVENTION

Hereafter, embodiments of the present invention are described with reference to drawings.

(Audio Signal Encoding Device)

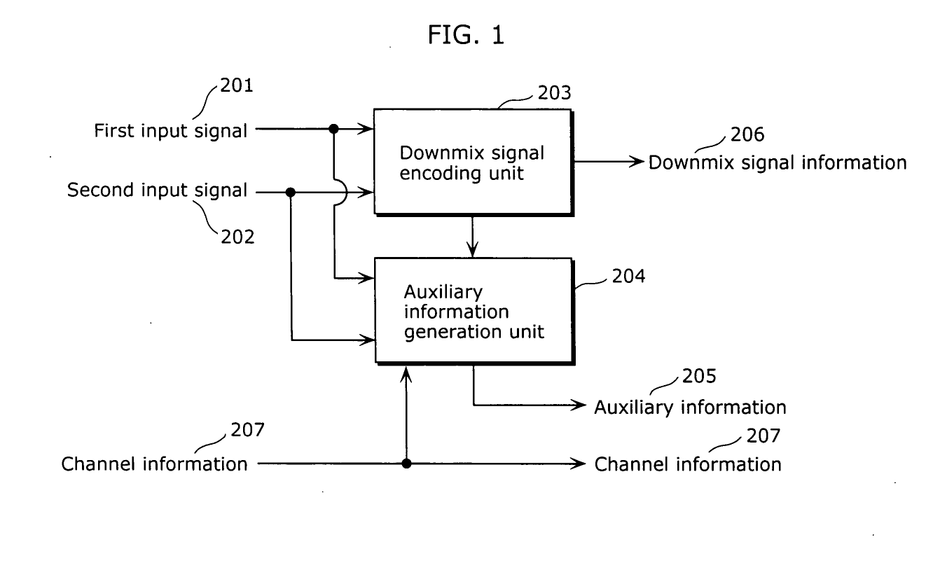

FIG. 1 is a block diagram showing an example of a functional structure of an audio signal encoding device of the present invention. The audio signal encoding device encodes a first input signal 201 and a second input signal 202 inputted from the outside, and obtains downmix signal information 206 while obtaining auxiliary information 205 using an encoding method that differs depending on a relation of reproduction locations of sounds of respective channels shown in the channel information 207 given from the outside. The audio signal encoding device includes a downmix signal encoding unit 203 and an auxiliary information generation unit 204.

The downmix signal information 206 and the auxiliary information 205 are information to be decoded into a signal that approximates the first input signal 201 and the second input signal 202. The channel information 207 is information indicating the direction, as seen by a listener, from which the respective signals to be decoded are reproduced.

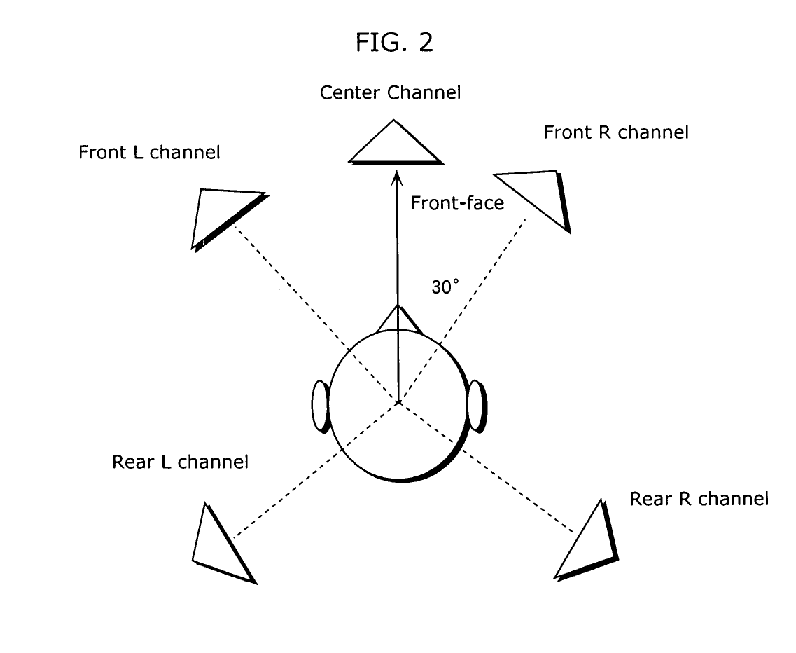

FIG. 2 is a diagram showing an example of a location relation between a sound source for a signal reproduction and the listener. This example shows location directions, as seen from the listener, of respective speakers that are sound sources of respective channels when reproduction is performed from five channels. For example, it is indicated that a front L channel speaker and a front R channel speaker are respectively located in directions with an angle of 30° toward left and right, as seen from the front-face of the listener. These two speakers are also used for a stereo reproduction.

The channel information 207 indicates, for example, the sound that should be reproduced from the front L channel speaker and the front R channel speaker is encoded, specifically using location angles of sound sources of +30° (front L channel speaker) and −30° (front R channel speaker) in a counter-clockwise direction when a front-face direction of the listener is set to 0°. Also, practically speaking, the channel information 207 can be indicated not only by fine angle information such as 30°, but also simply by channel names such as front L channel and front R channel while defining, in advance, the location angles of sound sources of respective channels.

The channel information 207 is provided to the audio signal encoding device appropriately from an external device that knows which channel of a sound to be encoded.

As one typical example, the channel information 207 indicating the front L channel and the front R channel is provided, in the case where stereo original sound signals are inputted respectively as the first input signal 201 and the second input signal 202 and where a monaural downmix signal and auxiliary information are generated therefrom.

As another typical example, the channel information 207 indicating the front L channel and the rear L channel is provided when two downmix signals of left and right channels is generated from original sound signals of 5 channels, in the case where the front L channel and the rear L channel are inputted respectively as the first input signal 201 and the second input signal 202 and where a downmix signal and auxiliary information of a left channel are generated therefrom.

Refer to FIG. 1 again, the first input signal 201 and the second input signal 202 are respectively inputted to the downmix signal encoding unit 203 and the auxiliary information generation unit 204. The downmix signal encoding unit 203 generates a downmix signal by summing the first input signal 201 and the second input signal 202 using a specific predetermined method, and outputs downmix signal information 206 obtained by encoding the downmix signal. A known technique can be arbitrarily applied to this encoding. For example, the AAC described in the background art and the like may be used.

The auxiliary information generation unit 204 generates auxiliary information 205 using the channel information 207 from the first input signal 201, the second input signal 202, the downmix signal generated by the downmix signal encoding unit 203, and the downmix signal information 206.

Here, the auxiliary information 205 is information for separating, from the downmix signal, respective signals that are auditory most approximate to the first input signal 201 and the second input signal 202 that are original sound signals before being downmixed. Here, using the auxiliary information 205, from the downmix signal, respective signals that are completely same as the pre-downmix first input signal 201 and the pre-downmix second input signal 202 can be separated; or respective signals in a degree of which the listener cannot hear the difference with the pre-downmix first signal 201 and the pre-downmix second input signal 202 can be separated. Even if the difference is heard, it is included in a range of the present invention as far as the auxiliary information is the information for signal separation.

The auxiliary information generation unit 204 generates auxiliary information which can separate an auditory reasonable signal with a small amount of information using the channel information 207. Therefore, the auxiliary information generation unit 204 switches a method of encoding the auxiliary information, specifically, a quantization precision for encoding, in accordance with the channel information 207.

Hereafter, some of the embodiments of the auxiliary information generation unit 204 are described in detail.

### FIRST EMBODIMENT

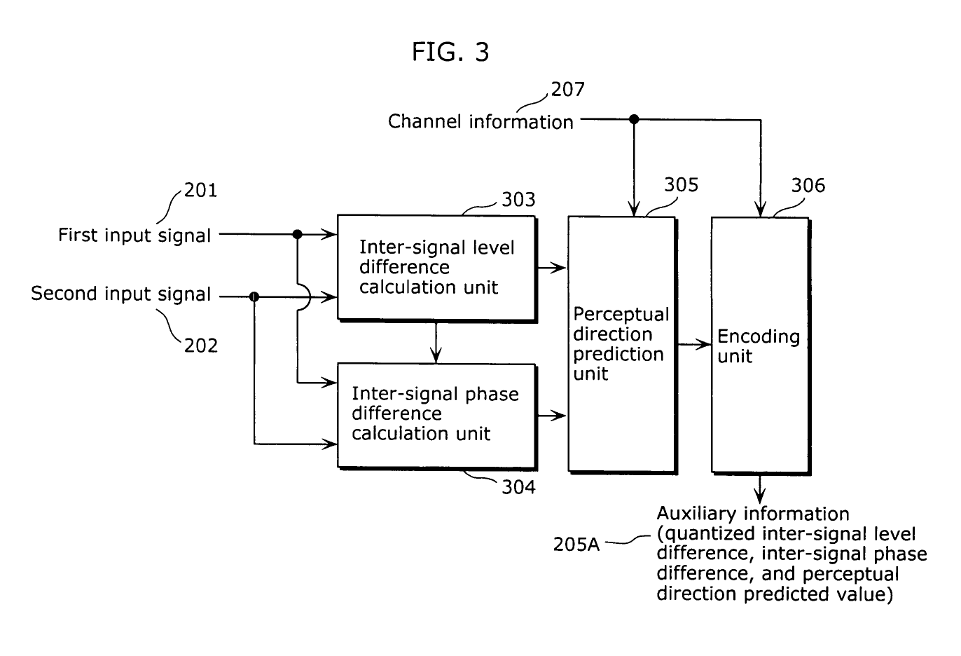

The auxiliary information generation unit according to the first embodiment is described with reference to FIG. 3 to FIG. 5.

FIG. 3 is a block diagram showing a functional structure of the auxiliary information generation unit according to the first embodiment.

The auxiliary information generation unit in the first embodiment is a unit of generating, from the first input signal 201 and the second input signal 202, auxiliary information 205A that is encoded differently depending on the channel information 207. It includes an inter-signal level difference calculation unit 303, an inter-signal phase difference calculation unit 304, a perceptual direction prediction unit 305, and an encoding unit 306.

The auxiliary information 205A is information obtained by quantizing and encoding one of an inter-signal level difference calculated by the inter-signal level difference calculation unit 303, an inter-signal phase difference calculated by the inter-signal phase difference calculation unit 304, and a perceptual direction predicted value calculated by the perceptual direction prediction unit 305.

The first input signal 201 and the second input signal 202 are inputted to the inter-signal level difference calculation unit 303 and the inter-signal phase difference calculation unit 304.

The inter-signal level difference calculation unit 303 calculates a difference of signal energy between the first input signal 201 and the second input signal 202. In the case of calculating the energy difference, it may be calculated for each frequency band obtained from dividing a signal into a plurality of frequency bands or for the whole band. Also, a time unit for the calculation is not particularly restricted. As a method of representing the energy difference, not necessarily limited to the above, the difference may be represented, for example, as dB that is an exponential function value often used for an audio representation.

The inter-signal phase difference calculation unit 304 calculates a cross-correlation between the first input signal 201 and the second input signal 202, and calculates a phase difference which gives a greater cross-correlation value. Such phase difference calculation method has been known to those skilled in the art. Also, it is not necessary to determine a phase giving the maximum cross-correlation value as the phase difference. This is because, in the case where the cross-correlation value is calculated based on the digital signal, the cross-correlation value is a discrete value so that a discrete value is also obtained for the phase difference. As the resolution, the phase difference may be set to the value predicted by interpolation based on the distribution of cross-correlation values.

The inter-signal level difference obtained as an output from the inter-signal level difference calculation unit 303, the inter-signal phase difference obtained as an output from the inter-signal phase difference calculation unit 304, and the channel information 207 are inputted to the perceptual direction prediction unit 305.

The perceptual direction prediction unit 305 predicts a direction of an acoustic image perceived by a listener, based on the channel information 207, the inter-signal level difference obtained as an output from the inter-signal level difference calculation unit 303, and the inter-signal phase difference obtained as an output form the inter-signal phase difference calculation unit 304.

In general, it has been known that the direction perceived by a listener when a sound signal is presented from two speakers is determined by the level difference and phase difference of 2 channel signals (Blauert, Jens., Masahiro Morimoto, and Toshiyuki Gotoh, eds. Space Acoustic. Kashima Publications, 1986. Spatial Hearing: The Psychophysics of Human Sound Localization, revised edition, MIT Press, 1997). The perceptual direction prediction unit 305, for example, based on these findings, predicts a perceptional direction of an acoustic image perceived by the listener, and outputs a perceptional direction predicted value indicating the prediction result to the encoding unit 306.

The encoding unit 306 quantizes, with a precision that differs according to the channel information 207 and the perceptual direction predicted value, at least one of the inter-signal level difference, the inter-signal phase difference, and the perceptual direction predicted value, and outputs auxiliary information 205A obtained through further encoding.

In the conventional technology, the followings have been known about listener's perception discrimination characteristics. In general, the listener's perception discrimination characteristic is laterally symmetrical against a front face direction, and has a tendency of being sensitive to the front face direction and being insensitive toward the front L channel direction (or front R channel direction). Also, in general, the listener's perception discrimination characteristic is longitudinally asymmetrical in counterclockwise from the front face direction to the rear face direction, and has a tendency of being sensitive to the front face direction and being insensitive toward the direction of the rear channel.

Taking that into consideration, when the perceptual direction predicted value obtained from the perceptual direction prediction unit 305 indicates a direction toward which the perception discrimination characteristic is sensitive, the encoding unit 306 finely quantizes the inter-signal level difference, the inter-signal phase difference and the perceptual direction predicted value, while it quantizes the difference more roughly when the direction toward which the perception discrimination characteristic is insensitive is indicated.

Specifically, when the channel information 207 indicates the front L channel and R channel, the encoding unit 306 performs quantization to be laterally symmetrical in respect to the perceptual direction, and when the channel information 207 indicates the front L channel and the rear L channel, it performs quantization to be longitudinal asymmetrical in respect to the perceptual direction.

In order to perform such switching of quantization precisions, the encoding unit 306, as an example, holds tables in advance, each of which converts an input value into a quantized value, and uses one of the tables which corresponds to the channel information 207.

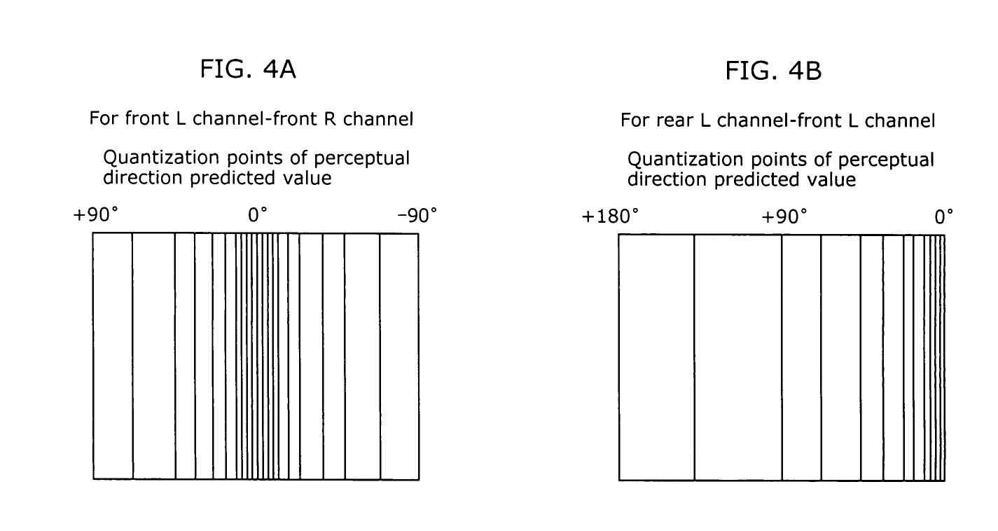

FIG. 4 is a schematic diagram showing an example of a table that is held in the encoding unit 306 in advance and used for a quantization of the perceptual direction predicted value. Any one of the tables indicates one example of quantization points of a perceptual direction predicted value. Here, FIG. 4A is an example of a table for a front L channel and a front R channel; and FIG. 4B is an example of a table for a rear L channel and a front L channel.

In the case where the channel information 207 indicates the front L channel and the front R channel, the encoding unit 306 quantizes, based on the table shown in FIG. 4A, the perceptual direction predicted value more finely near the front face direction toward which the perception discrimination characteristic is relatively sensitive, and quantizes it more roughly toward the lateral direction toward which the perception discrimination characteristic is relatively insensitive.

Also, in the case where the channel information 207 indicates the rear L channel and the front L channel, the encoding unit 306, based on the table shown in FIG. 4B, quantizes the perceptual direction predicted value more finely near the front face direction toward which the perception discrimination characteristic is relatively sensitive, and quantizes it more roughly toward a rear face direction toward which the perception discrimination characteristic is relatively insensitive.

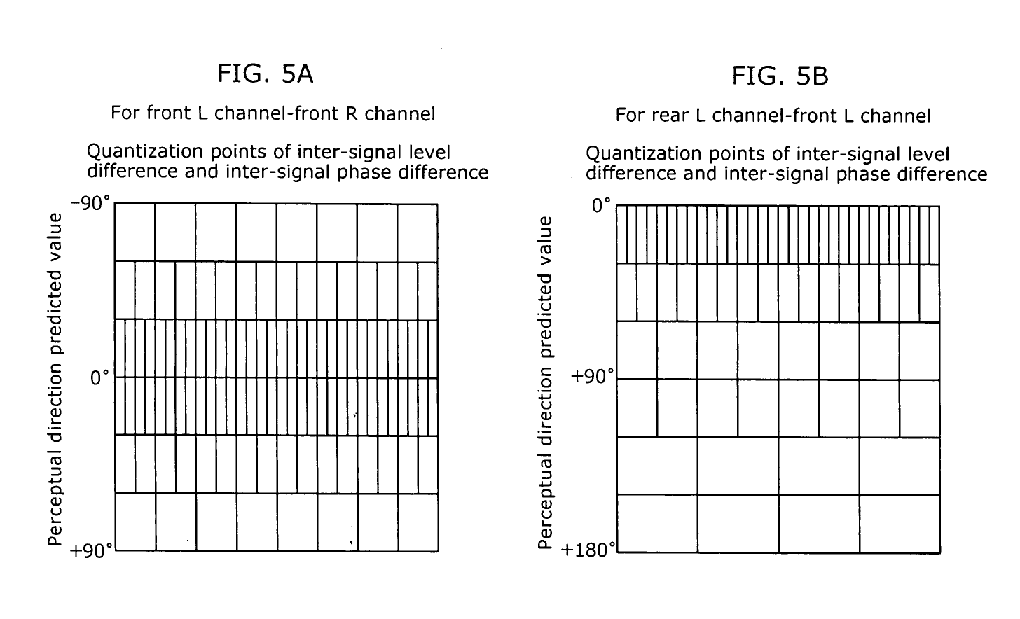

FIG. 5 is a schematic diagram showing an example of a table used for the quantization of the inter-signal level difference and the inter-signal phase difference. Any one of the tables indicates an example of quantization points of the inter-signal level difference and the inter-signal phase difference that are normalized in a predetermined normalization. Here, FIG. 5A indicates an example of a table for the front L channel and the front R channel; and FIG. 5B is an example of a table for the rear L channel and the front L channel.

In the case where the channel information 207 indicates the front L channel and the front R channel, the encoding unit 306 quantizes finely, based on the table shown in FIG. 5A, the inter-signal level difference and the inter-signal phase difference when the perceptual direction predicted value indicates near the front face direction toward which the perception discrimination characteristic is relatively sensitive, and quantizes the inter-signal level difference and the inter-signal phase difference more roughly as the perceptual direction predicted value is the value toward the lateral direction in which the perception discrimination characteristic is relatively insensitive.

Further, in the case where the channel information 207 indicates the rear L channel and the front L channel, based on the table shown in FIG. 5B, the encoding unit 306 finely quantizes the inter-signal level difference and the inter-signal phase difference when the perceptual direction predicted value indicates the value near the front face direction in which the perception discrimination characteristic is relatively sensitive, and quantizes the inter-signal level difference and the inter-signal phase difference more roughly when the perceptual direction predicted value indicates the value toward the rear face direction in which the perception discrimination characteristic is relatively insensitive.

Note that any one of the tables shown in FIGS. 4 and FIGS. 5 are specific examples of a structure for switching an encoding method in accordance with the channel information 207 as a feature of the present invention. Thus, it is not intended to restrict the quantization point distribution to the details shown in the diagrams. The present invention can include a case where a table indicating other distributions of quantization points reflecting the listener's perception discrimination characteristic such as where the channel information 207 indicates the rear L channel and the rear R channel.

Besides the structure of switching tables, it is acceptable to switch an encoding method according to the channel information 207 by switching, for example, quantization functions and a process of encoding itself.

As described above, the encoding unit 306, based on the channel information 207 and the perceptual direction predicted value obtained from the perceptual direction prediction unit 305, determines a quantization precision (i.e. a quantization precision that is finer toward the front face direction and rougher in a direction from the lateral direction toward the rear face direction) reflecting a discrimination capability relating to a listener's acoustic image perceptual direction, quantizes and encodes at least one of the inter-signal level difference, the inter-signal phase difference, and the perceptual direction predicted value.

Accordingly, the auxiliary information shown with lesser amount of information than the case of not switching the quantization precisions can be obtained.

For deciding a quantization precision, the quantization may be performed by generating a quantization table and a quantization function based on the psychoacoustic model for the case when the sound source is stopped, or the quantization precision may be changed at an actual sound source, considering that the acoustic image moves, in accordance with characteristics of a moving speed of the acoustic image and a frequency band to be quantized. In particular, by appropriately changing a temporal resolution, quantization and encoding can be performed by applying to a model used when the sound source is stopped.

Using such configured encoding method, encoding based on the characteristics of a human's sound perceptual direction can be performed and encoding can be efficiently performed.

### SECOND EMBODIMENT

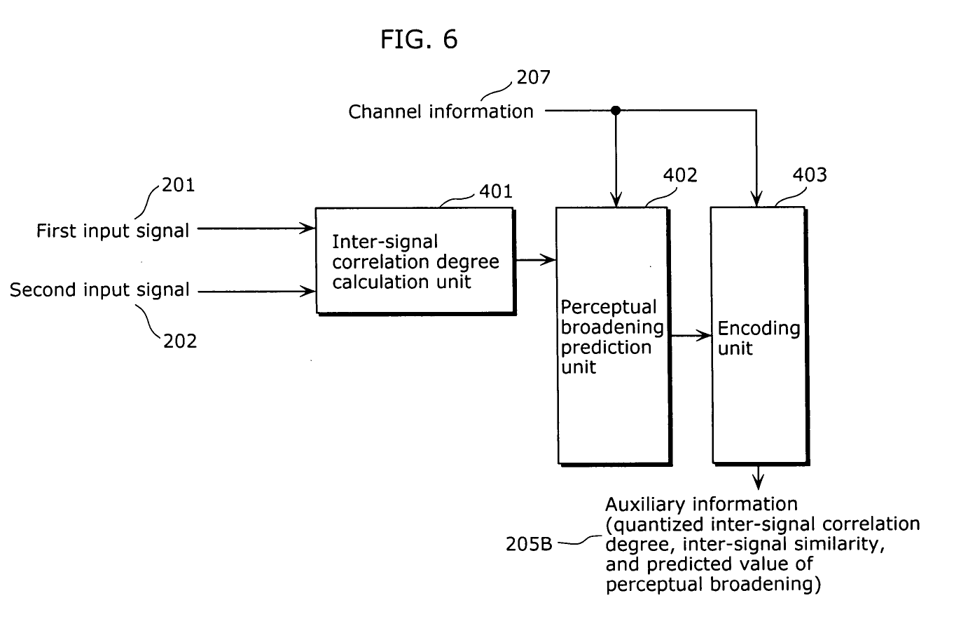

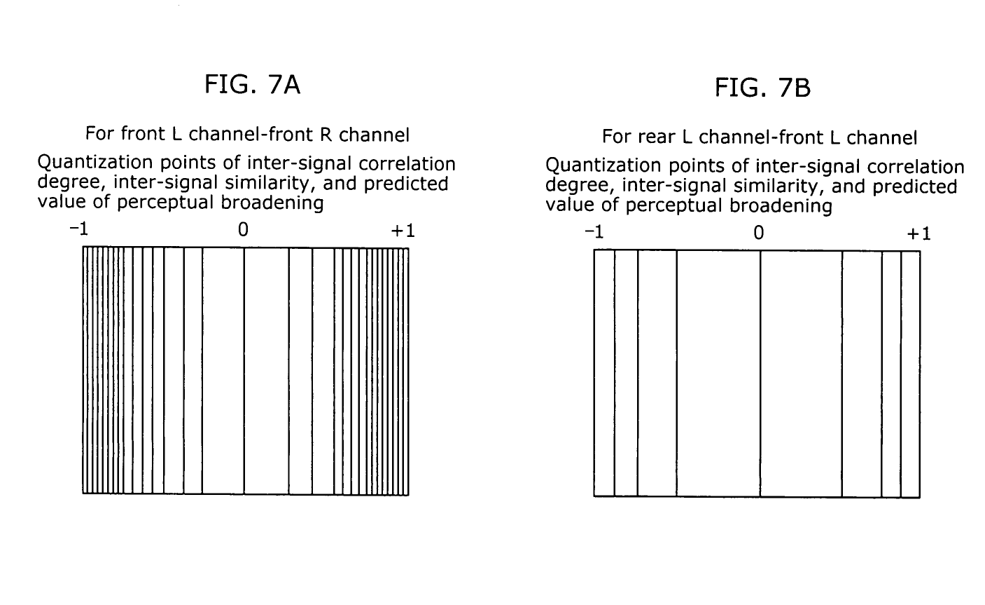

An auxiliary information generation unit according to the second embodiment is described with reference to FIG. 6 and FIG. 7.

FIG. 6 is a block diagram showing a functional structure of the auxiliary information generation unit in the second embodiment.

The auxiliary information generation unit in the second embodiment generates auxiliary information 205B encoded in accordance with the channel information 207 from the first input signal 201 and the second input signal 202, and is made up of an inter-signal correlation degree calculation unit 401, a perceptual broadening prediction unit 402, and an encoding unit 403.

Here, the auxiliary information 205B is information obtained by quantizing and encoding at least one of the inter-signal correlation degree calculated by the inter-signal signal correlation degree calculation unit 401, the inter-signal similarity degree, and a perceptual broadening predicted value calculated by the perceptual broadening prediction unit 402.

The first input signal 201 and the second input signal 202 are inputted to the inter-signal correlation degree calculation unit 401.

The inter-signal correlation degree calculation unit 401 calculates a degree of similarity (coherence) between signals based on a cross-correlation value between the first input signal 201 and the second input signal 202 and each input signal, for example, using the following equation 1.
ICC=Σ(x*(y+τ))/(Σx*x·Σy*y)ˆ0.5 (Equation 1)

τ is a term for correcting a binaural phase difference and has been known for those skilled in the art.

In the case of calculating the similarity degree, it may be calculated, for each band obtained by dividing a signal into a plurality of frequency bands, or for a whole band. Also, a time unit for the calculation is not particularly restricted.

The similarity degree between signals to be obtained from the inter-signal correlation degree calculation unit 401 as an output and the channel information 207 are inputted to the perceptual broadening prediction unit 402.

The perceptual broadening prediction unit 402 predicts a degree of perceptual broadening of an acoustic image perceived by a listener based on the channel information 207 and the similarity degree between signals obtained from the inter-signal correlation degree calculation unit 401 as an output. Here, the degree of broadening of the acoustic image perceived by the listener is described by digitizing the psychologically perceived range of the perceptual broadening appropriately.

In general, it has been known that the perceptual broadening of sound can be explained by a sound pressure level of an acoustic signal inputted into both ears of the listener and the binaural correlation degree (Japanese Patents No. 3195491 and No. 3214255). Here, a degree of interaural cross-correlation (DICC) and a degree of inter-channel cross-correlation (ICCC) have a relation shown by the following equation 2.
DICC=ICCC*Clr (Equation 2)

Here, Clr is a degree of cross-correlation between HI and Hr, where HI is a transfer function from a sound source such as a speaker to a left ear of the listener, and Hr is a transfer function from the sound source such as a speaker to a right ear of the listener. Here, in the case where speakers are located to be laterally symmetrical to each other as in a listening room, Clr is considered as 1. Therefore, the perceptual broadening of the acoustic image can be predicted from the degree of inter-signal correlation and a sound pressure level. The perceptual broadening prediction unit 402, for example, based on this knowledge, predicts a perceptual broadening of a sound perceived by the listener, and outputs the perceptual broadening predicted value indicating said prediction result is outputted to the encoding unit 403.

The encoding unit 403 quantizes at least one of the inter-signal correlation degree, the inter-signal similarity degree, and the perceptual broadening predicted value, with a different precision in accordance with the aforementioned channel information 207, and further outputs the auxiliary information 205B obtained through encoding.

In the conventional technology, in the case where a direction of a direct sound is not perceived by a listener from the front face direction of the listener even with the same degree of binaural cross-correlation, it has been known that the perceptual broadening is reduced compared to the case where a direct sound is perceived from the front face direction (M. Morimoto, K. Ikida, and Y. Furue, “Relation between Auditory Source Width in Various Sound Fields and Degree of Interaural Cross-Correlation”, Applied Acoustics, 38 (1993), 291-301).

This indicates that a listener's capability to discriminate the perceptual broadening of the reproduction sound is degraded in the case where the sound is reproduced from the front L channel and the rear L channel compared to the case where the sound is reproduced from the front L channel and the front R channel.

Taking that into consideration, the encoding unit 403 performs quantization with different precision for the case where the channel information 207 indicates the front L channel and the front R channel, and for the case where it indicates the front L channel and the rear L channel.

In order to perform such switching of quantization precision, the encoding unit 403, as an example, holds tables in advance, each of which converts an input value into a quantized value, and uses one of the tables which corresponds to the channel information 207.

FIG. 7 shows a schematic diagram showing an example of a table used for quantizing the inter-signal correlation degree, the inter-signal similarity degree, and the perceptual broadening predicted value that are held in advance in the encoding unit 403. Any one of the tables shows an example of quantization points of the inter-signal correlation degree, similarity degree, and perceptual broadening predicted value that are processed for predetermined normalization. FIG. 7A shows an example of a table for the front L channel and the front R channel. FIG. 7B shows an example of a table for the rear L channel and the front L channel.

In the case where the channel information 207 indicates the front L channel and the front R channel, the encoding unit 403 quantizes relatively finely the inter-signal correlation degree, the inter-signal similarity degree and the perceptual broadening predicted value, based on the table shown in FIG. 7A, and, in the case where the channel information 207 indicates the rear L channel and the front L channel, quantizes relatively roughly the inter-signal correlation degree, the inter-signal similarity degree, and the perceptual broadening predicted value, based on the table shown in FIG. 7B.

As described above, the encoding unit 403 determines, based on the channel information 207, a quantization precision (i.e. a quantization precision which is finer toward the front face direction and rougher in a direction from the lateral to rear face direction) reflecting a listener's capability of discriminating a perceptual broadening, and quantizes and encodes, at the determined quantization precision, at least one of the inter-signal cross-correlation degree, the inter-signal similarity degree, and the perceptual broadening predicted value.

Using such configured encoding method, encoding based on the characteristics of human's perceptual broadening for the acoustic image can be realized and encoding can be efficiently performed.

### THIRD EMBODIMENT

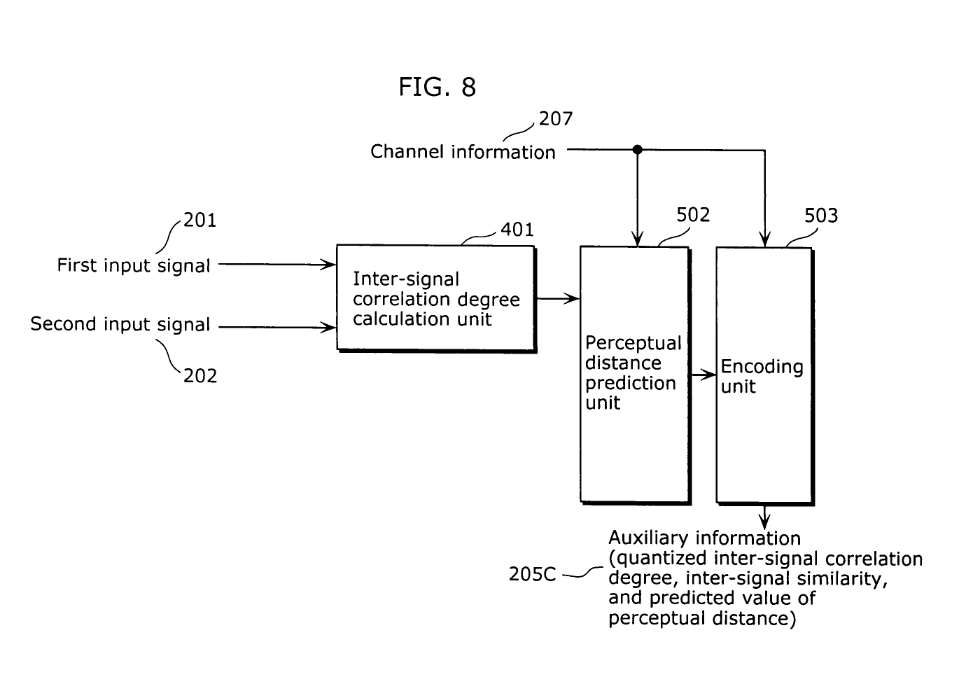

An auxiliary information generation unit according to the third embodiment is described with reference to FIG. 8.

FIG. 8 is a block diagram showing a functional structure of the auxiliary information generation unit according to the third embodiment.

The auxiliary information generation unit according to the third embodiment generates, from the first input signal 201 and the second input signal 202, auxiliary information 205C that is encoded in accordance with the channel information 207. It includes an inter-signal correlation degree calculation unit 401, a perceptual distance prediction unit 502, and an encoding unit 503.

Here, the auxiliary information 205C is information obtained by quantizing and encoding at least one of the inter-signal correlation degree calculated by the inter-signal correlation degree calculation unit 401, the inter-signal similarity degree, and the perceptual distance predicted value calculated by the perceptual distance prediction unit 502.

The first input signal 201 and the second input signal 202 are inputted to the inter-signal correlation degree calculation unit 401.

The inter-signal correlation degree calculation unit 401 calculates a degree of similarity (coherence) between signals based on the cross-correlation value between the first input signal 201 and the second input signal 202, and on each input signal using the aforementioned equation 1 and the like.

In the case of calculating the similarity degree, it may be calculated for each frequency band obtained by dividing a signal into a plurality of frequency bands, or for the whole band. Also, the time unit for the calculation is not particularly restricted.

The similarity between signals obtained as an output from the inter-signal correlation degree calculation unit 401 and the channel information 207 are inputted to the perceptual distance prediction unit 502.

The perceptual distance prediction unit 502 predicts a degree of perceptual distance of an acoustic image perceived by the listener based on the channel information 207 and the inter-signal similarity degree obtained as an output from the inter-signal correlation degree calculation unit 401. Here, the degree of perceptual distance of the acoustic image perceived by the listener is described by digitizing the psychologically perceived distance and closeness appropriately.

Conventionally, it has been known that there is a relation between the perceptual distance of the acoustic image perceived by the listener and the positive and negative signs of the output value (similarity degree) calculated by the inter-signal correlation degree calculation unit 401 using the aforementioned equation 1. This is described by Koichi Kuroizumi, et al., “The Relationship between the Cross-correlation Coefficient and Sound Image Quality of Two-channel acoustic signals”, Journal of Acoustical Society of Japan, vol. 39, no. 4, 1983. The perceptual distance prediction unit 502, for example, predicts the perceptual distance of the acoustic image perceived by the listener based on this knowledge, and outputs the perceptual distance predicted value indicating the prediction result to the encoding unit 503.

The encoding unit 503 quantizes at least one of the inter-signal correlation degree, the inter-signal similarity degree and the perceptual distance predicted value, with a respective precision that is different in accordance with the aforementioned channel information 207, and further outputs auxiliary information 205C obtained through encoding.

Also, with respect to the perceptual distance of a reproduction sound, it is predicted that a discrimination capability of the listener is different for the case where the sound is reproduced from the front L channel and the front R channel, and for the case where the sound is reproduced from the front L channel and the rear L channel.

Considering the above, the encoding unit 503 performs different quantization for the case where the channel information 207 indicates the front L channel and the front R channel, and for the case where the front L channel and the rear L channel.

In order to perform such switching of the quantization precisions, the encoding unit 503, for example, holds tables in advance, each of which converts an input value into a quantized value, and uses one of the tables which corresponds to the channel information 207. The same table as described in FIG. 7 is used for such table so that the detailed explanation about the table is not repeated here.

As described above, the encoding unit 503, based on the channel information 207, decides a quantization precision reflecting a discrimination capability relating to a perceptual distance to the acoustic image perceived by the listener (i.e. a quantization precision which is finer in a front face direction and becomes rougher in a direction toward a lateral to rear face direction), quantizes and encodes, with the determined quantization precision, at least one of the inter-signal correlation degree, the inter-signal similarity degree, and the perceptual distance predicted value.

Using such configured encoding method, encoding can be performed based on a human's characteristic of a perceptual distance to an acoustic image, and the encoding can efficiently performed.

### FOURTH EMBODIMENT

An audio signal encoding device according to the fourth embodiment is a combination of the audio signal encoding devices of the first, second and third embodiments.

The audio signal encoding device of the fourth embodiment having all structures shown in FIGS. 3, 6 and 8, performs encoding by calculating, from two input signals, an inter-signal level difference, an inter-signal phase difference and an inter-signal correlation degree (a degree of similarity), predicting, based on channel information, a perceptual direction, a perceptual broadening and a perceptual distance, and switching quantization methods and quantization tables.

Note that, in the fourth embodiment, any two of the first to third embodiments may be combined.

(Audio Decoding Device)

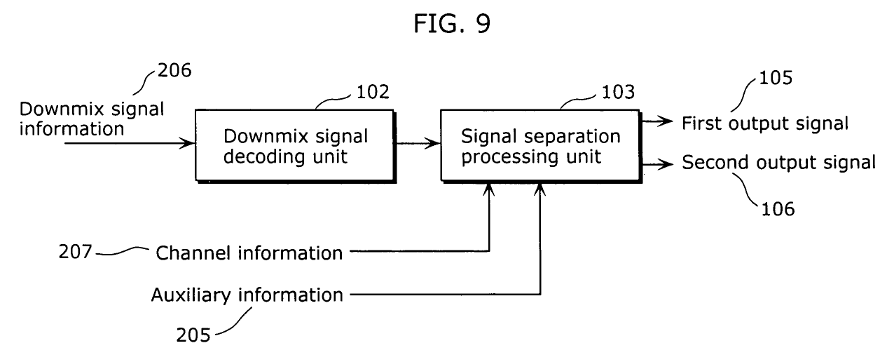

FIG. 9 is a block diagram showing an example of a functional structure of an audio signal decoding device according to the present invention. The audio signal decoding device decodes a first output signal 105 and a second output signal 106 that are approximated to original sound signals based on downmix signal information 206, auxiliary information 205, and channel information 207 that are generated by the aforementioned audio signal encoding device. It includes a downmix signal decoding unit 102 and a signal separation processing unit 103.

While the present invention does not restrict a specific method of transferring, from the audio signal encoding device to an audio signal decoding device, the downmix signal information 206, the auxiliary information 205 and the channel information 207, as an example, the downmix signal information 206, the auxiliary information 205 and the channel information 207 are multiplexed into a broadcast stream and the broadcast stream is transferred; and the audio signal decoding device may acquire the downmix signal information 206, the auxiliary information 205 and the channel information 207 by receiving and demultiplexing the broadcast stream.

Also, for example, in the case where the downmix signal information 206, the auxiliary information 205 and the channel information 207 are stored in a recording medium, the audio signal decoding device may read out, from the recording medium, the downmix signal information 206, the auxiliary information 205 and the channel information 207.

Note that, the transmission of the channel information 207, is possibly omitted by defining, in advance, a predetermined value and order between the audio signal encoding device and the audio signal decoding device.

The downmix signal decoding unit 102 decodes the downmix signal information 206 indicated in an encoded data format into an audio signal format, and outputs the decoded audio signal into the signal separation processing unit 103. The downmix signal decoding unit 102 performs inverse transformation performed by the downmix signal encoding unit 203 in the aforementioned audio signal encoding device. For example, in the case where the downmix signal encoding unit 203 generates the downmix signal information 206 in accordance with AAC, the downmix signal decoding unit 102 also acquires the audio signal by performing inverse-transformation determined by the AAC. The audio signal format is selected from a signal format on a time axis, a signal format on a frequency axis, and a format described with both time and frequency axes, so that the present invention does not restrict its format.

The signal separation processing unit 103 generates and outputs, from the audio signal outputted from the downmix signal decoding unit 102, a first output signal 105 and a second output signal 106, based on the auxiliary information 205 and the channel information 207.

Hereafter, the details about the signal separation processing unit 103 are described.

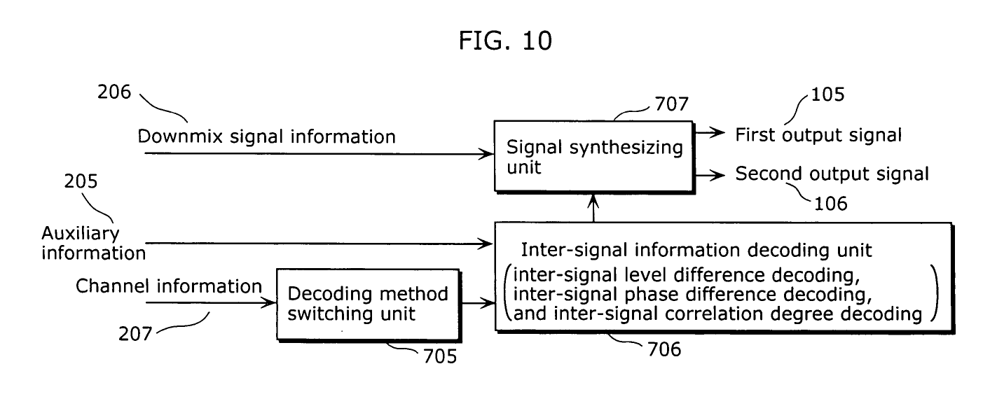

FIG. 10 is a block diagram showing a functional structure of the signal separation processing unit 103 according to the present embodiment.

The signal separation processing unit 103 decodes the auxiliary information 205 using a different decoding method in accordance with the channel information 207, and generates the first output signal 105 and the second output signal 106 using the decoding result. It includes a decoding method switching unit 705, an inter-signal information decoding unit 706 and a signal synthesizing unit 707.

When the channel information 207 is inputted, the decoding method switching unit 705 instructs the inter-signal information decoding unit 706 to switch a decoding method based on the channel information 207.

The inter-signal information decoding unit 706 decodes the auxiliary information 702 into inter-signal information using the decoding method switched in accordance with the instruction from the decoding method switching unit 705. The inter-signal information is the inter-signal level difference, the inter-signal phase difference and the inter-signal correlation degree as described in the first to third embodiments. As in the case of the encoding unit in the audio signal encoding device, the inter-signal information decoding unit 706 can switch decoding methods by switching tables indicating quantization points. Also, the decoding method may be changed by changing, for example, an inverse-function of the quantization and a procedure of decoding itself.

The signal synthesizing unit 707 generates, from an audio signal that is an output signal of the downmix signal decoding unit 704, the first output signal 105 and the second output signal 106 which have the inter-signal level difference, the inter-signal phase difference and the inter-signal correlation degree indicated in the inter-signal information. For this generation, the following known method may be arbitrarily used; applying, in opposite directions, respective halves of the inter-signal level difference and of the inter-signal phase difference to two signals obtained by duplicating the audio signal, and further downmixing the two signals to which the level difference and the phase difference have been applied, in accordance with the inter-signal correlation degree.

Using such configured decoding method, an effective decoding method reflecting the channel information can be achieved and a plurality of high-quality signals can be obtained.

Also, this decoding method can be used not only for generating two-channel audio signal from one-channel audio signal, but also for generating an audio signal having more than n channels from n-channel audio signal. For example, the decoding method is effective for the case where 6-channel audio signal is acquired from 2-channel audio signal, or for the case where 6-channel audio signal is acquired from 1-channel audio signal.

### INDUSTRIAL APPLICABILITY

In addition, an audio signal decoding device, an audio signal encoding device and a method thereof according to the present invention can be used for a system of transmitting a bit stream which is audio encoded, for example, a transmission system of broadcast contents, a system of recording and reproducing audio information in a recording medium such as a DVD and a SD card, and a system of transmitting an AV content to a communication appliance represented by a cellular phone. It can be also used in a system of transmitting an audio signal, as electronic data communicated over the Internet.

1-18. (canceled)

19. An audio signal encoding device which encodes original sound signals of respective channels into downmix signal information and auxiliary information, the downmix signal information indicating an overall characteristic of the original sound signals, and the auxiliary information indicating an amount of characteristic based on a relation between the original sound signals, said device comprising:
a downmix signal encoding unit operable to encode a downmix signal acquired by downmixing the original sound signals so as to generate the downmix signal information; and
an auxiliary information generation unit operable to: calculate the amount of characteristic based on the original sound signals; when channel information indicating reproduction locations, as seen by a listener, of sounds of respective channels is given, determine an encoding method that differs depending on a location relation of the reproduction locations indicated in the given channel information; and generate the auxiliary information by encoding the calculated amount of characteristic using the determined encoding method.

20. The audio signal encoding device according to claim 19,
wherein said auxiliary information generation unit is operable to retain tables in advance, each table defining quantization points at which different quantization precisions are achieved, and
said auxiliary information generation unit is operable to encode the amount of characteristic by quantizing the amount of characteristic at the quantization points defined by one of the tables which corresponds to the location relation of the reproduction locations indicated in the channel information.

21. The audio signal encoding device according to claim 19,
wherein said auxiliary information generation unit is operable to calculate, as the amount of characteristic, at least one of a level difference and a phase difference between the original sound signals.

22. The audio signal encoding device according to claim 21,
wherein said auxiliary information generation unit is operable to calculate both of the level difference and the phase difference between the original sound signals, and to calculate, as the amount of characteristic, a direction of an acoustic image presumed to be perceived by the listener, based on the calculated level difference and phase difference.

23. The audio signal encoding device according to claim 21,
wherein said auxiliary information generation unit is operable to retain a first table and a second table in advance, the first table defining quantization points provided laterally symmetrical seen from a front face direction of the listener, and the second table defining quantization points provided longitudinally asymmetrical seen from a left direction of the listener, and
said auxiliary information generation unit is operable to encode the amount of characteristic (a) by quantizing the amount of characteristic at the quantization points defined by the first table, in the case where the channel information indicates front left and front right of the listener, and (b) by quantizing the amount of characteristic at the quantization points defined by the second table, in the case where the channel information indicates front left and rear left of the listener.

24. The audio signal encoding device according to claim 19,
wherein said auxiliary information generation unit is operable to calculate, as the amount of characteristic, a degree of similarity between the original sound signals.

25. The audio signal encoding device according to claim 24,
wherein said auxiliary information generation unit is operable to calculate, as the degree of similarity, one of a cross-correlation value between the original sound signals and an absolute value of the cross-correlation value.

26. The audio signal encoding device according to claim 24,
wherein said auxiliary information generation unit is operable to calculate, as the amount of characteristic, at least one of a perceptual broadening and a perceptual distance of an acoustic image presumed to be perceived by the listener, based on the calculated degree of similarity.

27. An audio signal decoding device which decodes downmix signal information and auxiliary information into reproduction signals of respective channels, the downmix signal information indicating an overall characteristic of original sound signals of the respective channels, and the auxiliary information indicating an amount of characteristic based on a relation between the original sound signals, said device comprising:
a decoding method switching unit operable to determine, when channel information indicating reproduction locations, as seen by a listener, of sounds from the respective channels is given, a decoding method that differs depending on a location relation of the reproduction locations indicated in the given channel information;
an inter-signal information decoding unit operable to decode the auxiliary information into the amount of characteristic using the determined decoding method; and
a signal synthesizing unit operable to generate the reproduction signals of the respective channels, using the downmix signal information and the decoded amount of characteristic.

28. The audio signal decoding device according to claim 27,
wherein the auxiliary information is encoded by quantizing the amount of characteristic at quantization points defined by a table corresponding to the location relation of the reproduction locations indicated in the channel information, the table being one of tables, each defining quantization points at which different quantization precisions are achieved,
said inter-signal information decoding unit is operable to retain the tables in advance, and
said inter-signal information decoding unit is operable to decode the auxiliary information into the amount of characteristic using one of the tables which corresponds to the location relation of the reproduction locations indicated in the channel information.

29. The audio signal decoding device according to claim 28,
wherein the amount of characteristic indicates at least one of a level difference, phase difference between the original sound signals, and a direction of an acoustic image presumed to be perceived by the listener,
said inter-signal information decoding unit is operable to retain a first table and a second table in advance, the first table defining quantization points provided laterally symmetrical seen from a front face direction of the listener, and the second table defining quantization points provided longitudinally asymmetrical seen from a left direction of the listener, and
said inter-signal information decoding unit is operable to decode the auxiliary information (a) into the amount of characteristic using the first table, in the case where the channel information indicates front left and front right of the listener, and (b) into the amount of characteristic using the second table, in the case where the channel information indicates front left and rear left of the listener.

30. The audio signal decoding device according to claim 27,
wherein the amount of characteristic indicates at least one of a level difference, a phase difference and a similarity between the original sound signals, and a direction of an acoustic image, a perceptual broadening and a perceptual distance which are presumed to be perceived by the listener.

31. The audio signal decoding device according to claim 30,
wherein said signal synthesizing unit is operable to generate the reproduction signal, in the case where the amount of characteristic indicates at least one of the level difference, phase difference and similarity between the original sound signals, by applying a level difference, a phase difference and a similarity which correspond to the amount of characteristic, to a sound signal indicated by the downmix signal information.

32. An audio signal encoding method for encoding original sound signals of respective channels into downmix signal information and auxiliary information, the downmix signal information indicating an overall characteristic of the original sound signals, and the auxiliary information indicating an amount of characteristic based on a relation between the original sound signals, said method comprising:
a downmix signal encoding step of generating the downmix signal information by encoding a downmix signal acquired by downmixing the original sound signals; and
an auxiliary information generation step of: calculating the amount of characteristic based on the original sound signals; when channel information indicating reproduction locations, as seen by a listener, of sounds of the respective channels, determining an encoding method that differs depending on a location relation of the reproduction locations indicated in the given channel information; and generating the auxiliary information by encoding the calculated amount of characteristic using the determined encoding method.

33. An audio signal decoding method for decoding downmix signal information and auxiliary information into reproduction signals of respective channels, the downmix signal information indicating an overall characteristic of the original sound signals of the respective channels, the auxiliary information indicating an amount of characteristic based on a relation between the original sound signals, said method comprising:
a decoding method switching step of determining, when channel information indicating reproduction locations, as seen by a listener, of sounds of the respective channels is given, a decoding method that differs depending on a location relation of reproduction locations indicated in the given channel information;
an inter-signal information decoding step of decoding the auxiliary information into the amount of characteristic using the determined decoding method; and
a signal synthesizing step of generating reproduction signals of the respective channels using the downmix signal information and the decoded amount of characteristic.

34. A computer executable program for encoding original sound signals of respective channels into downmix signal information and auxiliary information, the downmix signal information indicating an overall characteristic of the original sound signals, and the auxiliary information indicating an amount of characteristic based on a relation between the original sound signals, said program comprising:
a downmix signal encoding step of generating the downmix signal information by encoding a downmix signal acquired by dowrnixing the original sound signals; and
an auxiliary information generation step of: calculating the amount of characteristic based on the original sound signals; when channel information indicating reproduction locations, as seen by a listener, of sounds of the respective channels is given, determining an encoding method that differs depending on a location relation of the reproduction locations indicated in the given channel information; and generating the auxiliary information by encoding the calculated amount of characteristic using the determined encoding method.

35. A computer executable program for decoding downmix signal information and auxiliary information into reproduction signals of respective channels, the downmix signal information indicating an overall characteristic of the original sound signals of the respective channels, the auxiliary information indicating an amount of characteristic based on a relation between the original sound signals, said program comprising:
a decoding method switching step of determining, when channel information indicating reproduction locations, as seen by a listener, of sounds of the respective channels is given, a decoding method that differs depending on a location relation of reproduction locations indicated in the given channel information;
an inter-signal information decoding step of decoding the auxiliary information into the amount of characteristic using the determined decoding method; and
a signal synthesizing step of generating reproduction signals of the respective channels using the downmix signal information and the decoded amount of characteristic.

36. A computer readable recording medium on which the program according to claim 34 is stored.

37. A computer readable recording medium on which the program according to claim 35 is stored.
